(19) United States
(12) Patent Application Publication
(10) Pub. No.: US 2007/0127356 A1
(43) Pub. Date: Jun. 7, 2007

(54) Reducing Interference (Noise) Caused by Specific Components of a Transmitter While Receiving a Signal in a Transceiver

(75) Inventors: Bijoy BHUKANIA, Bangalore (IN); Sundararajan Krishnan, Bangalore (IN); Sudheer PRASAD, Bangalore (IN)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/164,750

(22) Filed: Dec. 5, 2005

(51) Int. Cl. H04J 3/10

(52) U.S. Cl. 370/201

(57) ABSTRACT

A transceiver which effectively cancels interference caused by a component (e.g., driver) of a transmitter (contained in the transceiver). The input and output signals of the component are examined to estimate the magnitude of the interference, and the interference is canceled according to the estimate. Accordingly, the component need not be implemented with high accuracy/precision.

### BACKGROUND OF THE INVENTION

1. Field of the Invention

The present invention relates to communication systems and more specifically to a method and apparatus reducing interference caused by a transmitter while receiving a signal in a transceiver.

2. Related Art

Transceivers are often used both in wire-line and wireless telecommunication systems to transmit and receive stream of data bits. A transceiver typically contain a number of components (together referred to as “transmitter”) operating to transmit a desired data bits as transmit signal and number of components (“receiver”) operating to generate data bits from a received signal. Both sets of components are implemented together to support transmission and reception information (signals representing data bits) in a single component.

Generally, transmission includes generating a sequence of symbols from a stream of data bits, modulating the symbols on a carrier signal, amplifying the modulated signal and transmitting the amplified signal on a medium. Similarly, receiving include receiving a signal (from the medium), de-modulation to generate the symbols, and decoding of symbols to generate the sequence of data bits. A processing unit (be contained within the transceiver) provides the desired data bits for transmission and may receive the decoded data bits from receiving components for further processing.

One problem recognised with transceivers is that the signals generated (transmitted) by the transmitter may cause interference with the receiving operation, thereby causing an error in the decoded data bits. One example for such interference is a noise introduced into receive-signals while modulating and transmitting transmit-signals. Such noise is often formed by frequency components (generated by components operating to transmit signal such as amplifier, modulator etc. while generating and transmitting the transmit-signals) interfering with the receive signal.

Introduction of such noise into receive-signals is often undesirable. For example, in several environments, it is generally desirable to generate transmit-signals with a high strength (to enable a distant receiver to receive signals of acceptable strength), and the receive signals are feeble (due to the attenuation caused while propagating from distant source). Due to the need to generate transmit-signals with high strength, the noise generated may also be correspondingly strong. The presence of strong noise components in the receive-signals may present challenges in accurately recovering any information (analog or digital) encoded in the (otherwise feeble) receive-signals.

Accordingly, it may be desirable to eliminate (or substantially reduce) the noise components generated/introduced by the components associated with the transmit-signals.

### BRIEF DESCRIPTION OF THE DRAWINGS

Various features of the present invention are described with reference to the following accompanying drawings, which are briefly described below.

FIG. (FIG.) 1 is a block diagram illustrating the details of an example device in which several aspects of the present invention can be implemented.

FIG. 2 is a graph illustrating manner in which different frequency ranges are used for transmitting and receiving in a transceiver implemented according to DSL (digital subscriber line) technology in one embodiment.

FIGS. 3A and 3B are graphs illustrating manner in which an amplified signal may occupy different/more frequency bands than the frequency bands of an input signal.

FIG. 4 is a flowchart illustrating an approach to reduce interference in a transceiver according to an aspect of the present invention.

FIG. 5 is block diagram of an example embodiment in which various aspects of the present invention are implemented.

FIG. 6 is a block diagram illustrating the details of an example transceiver providing correction to inband interference caused due to non-linearity of a driver in the transmitter, according to an aspect of present invention.

FIG. 7 contains a graph illustrating the estimated interference in one embodiment.

In the drawings, like reference numbers generally indicate identical, functionally similar, and/or structurally similar elements. The drawing in which an element first appears is indicated by the leftmost digit (s) in the corresponding reference number.

### DETAILED DESCRIPTION

1. Overview

An aspect of the present invention provides for effective cancellation of interference (noise) introduced by a component of a transmitter (contained in a transceiver) on a receive path on which an external signal containing information of interest is received by a receiver (also contained in the transceiver). Such a feature is attained by estimating the magnitude of the interference based on the input signal and the output signal of the component, and cancelling the estimated magnitude from a combined signal (containing the external signal and the interference) on the receive path.

As a result, line drivers type components may be implemented with lesser precision thereby reducing the cost of the transceiver. Further, filtering requirements at the receiver may also be eliminated/reduced resulting in further reduction in cost, size and power consumption.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well known structures or operations are not shown in detail to avoid obscuring the features of the invention.

2 . Example Device

FIG. 1 is a block diagram illustrating an example device in which several aspects of the present invention can be implemented. Device 100 is shown containing transmitter 110, receiver 190 and processing block 150. Transmitter 110 and receiver 190 together form a transceiver (e.g., in a DSL modem). Each block is described below in further detail.

Transmitter 110 is further shown containing symbol generator 120, modulator block 130, digital to analog converter (DAC) 135 and driver 140. Symbol generator 120 generates sequence of symbols from a stream of data bits (desired data bits) received from processing block 150. Typically, each symbol represents a number of bits in the bits stream.

Modulator block 130 receives symbols on path 123 and modulates received symbols using a carrier signal (frequency). The modulated signal occupies a frequency band determined by carrier frequency (center of the frequency band) and the bandwidth of the symbols received on path 123. Digital to analog converter 135 receives the modulated signal on path 132 and generates an analog modulated signal on path 134. Driver 140 amplifies the received analog signal and transmits the amplified analog signal (transmit signal) on path 149 (e.g., by using antenna in case of wireless systems, and wire/cable in case of DSL systems, etc.).

Processing block 150 may potentially operate to provide various user applications such as web browsing, voice calls, teleconferencing, etc. by providing appropriate user interface. Accordingly, processing block 150 may generate data bits for transmission on path 152 and perform various operations on the received bit stream (on path 185).

Receiver device 190 is shown containing automatic gain controller (AGC) 160, analog to digital converter (ADC) 165, demodulator block 170 and symbol decoder 180. Receiver 190 receives a signal (received signal) on path 169 (e.g., by using antenna in case of wireless systems, and wire/cable in case of DSL systems, etc.) and a interference/noise signal (on path 146) generated by the transmitting components. The received (combined) signal is provided on path 162 to automatic gain controller (AGC) 160. The AGC provides a received signal with a substantially constant power to the analog to digital converter (ADC) 165.

Analog to digital converter (ADC) 165 generates digital representation of the received signal and provides the resulting digital codes on path 167. Demodulation block 170 demodulates the digital representation of received signal to extracts symbols using desired (locally generated) carrier signal (not shown) having frequency allocated/desired for receiving a signal. Symbol decoder 180 decodes sequence of symbols to generate a received data bits stream on path 185. The received data bits are provided to processing block 150 for further processing.

The received data bits on path 185 may potentially erroneous due to the interference signals received on path 146. The interference signals can be due to reasons such as spectral regrowth of the transmit signal, out of band emission by the transmitter (for example caused due to non-linear operation of driver 140, and/or quantization errors in DAC 135), etc.

In general the interference can reach path 162 in several forms depending on the medium using which the transmitter and receiver operate. For example, the interference can be received in the form of echo in case of shared transmit/receive wire_line path such as DSL, a radiation from transmit antenna in case of wireless systems, and on_board signal leakage between the components such as on board radiation. At least the effects of such an interference need to be reduced/eliminated for accurate recovery of the information contained in the signal received on path 169.

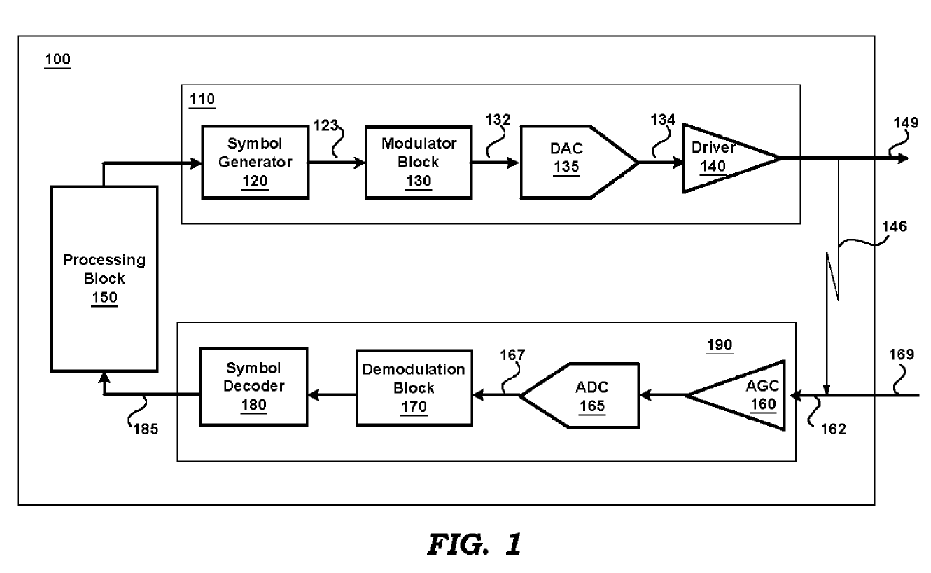

In one prior embodiment, such interference is reduced by using a different frequency bands (dual band) for transmitting operation and receiving operation. Due to the use of different frequency ranges, interference generated by transmitting components are in different frequency range compared to the received signal frequency range. Accordingly, interference may be eliminated/reduced by filtering techniques. Some limitations with such an approach (which are addressed for various aspects of the present invention) are illustrated below with reference to FIG. 2.

3. Limitations of Dual Band Approach

FIG. 2 is a graph illustrating manner in which different frequency ranges are used for transmitting and receiving in a transceiver implemented according to DSL (digital subscriber line) technique. Graph (X-axis representing frequency) is shown containing frequency bands 210, 220, 230, 240, 250 and 260 respectively having frequency ranges f1 to f2, f2 to f3, f3 to f4, f4 to f5, f5 to f6, and f6 to f7. Frequency bands (transmit bands) 220, 240, and 260 are used for transmitting signal/symbols and frequency bands (receive band) 210, 230 and 250 are used receive signals.

Continuing with respect to FIG. 1, modulator 130 modulates the sequence of symbols received on path 123 using multiple carrier frequencies (signals) each centered at transmit band 220, 240 and 260. The modulated transmit bands 220, 240 and 260 are ideally amplified by the driver (line driver)140 and transmitted on path 149.

Similarly, received signal in receive band 210, 230 and 250 are received on path 169 and demodulator 170 demodulates the received signal using multiple reference signals having frequency centered at receive band 210, 230 and 250 to extract symbols (information of interest).

Since, transmitting components operate at frequency bands 220, 240 and 260, ideally, interference/noise generated will be typically in the same frequency bands. Hence, a filter may be implemented to eliminate any signal in frequency bands 220, 240 and 260 and allow only receiving bands 210, 230 and 250. As a result, interference from transmitter 110 is eliminated.

However, a non-ideal component operating in bands 220, 240 and 260 may potentially introduce/generate a signal in the frequency ranges other than frequency ranges 220, 240 and 260. Hence the non-ideal operation may potentially introduce noise into the received signal. Example of such a scenario is illustrated below with respect to non-linearity of line driver 140.

4. Interference Due to Non-linearity of Line Driver.

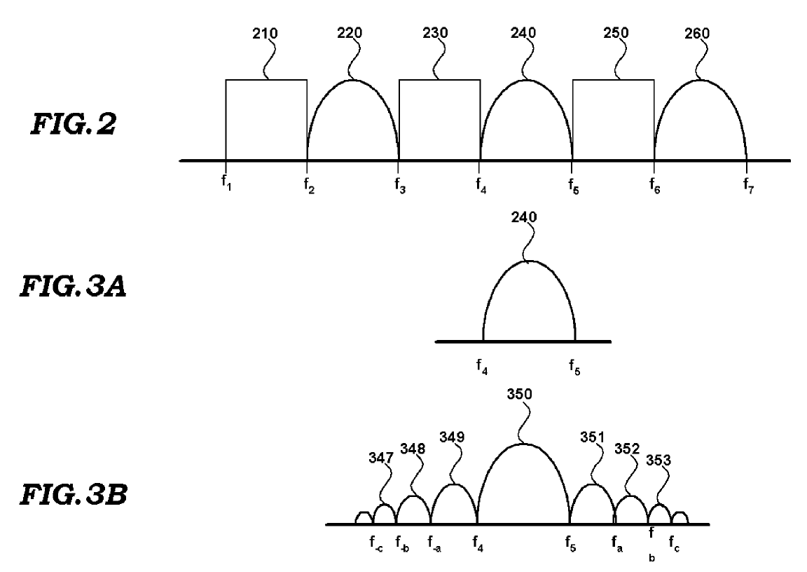

Line driver 140 amplifies transmitted signal in the transmitting bands 220,240,260. However, due to non-linearity, the amplified signal (output signal 149) may occupy a frequency band more/different from the desired transmitting frequency band. FIGS. 3A and 3B are graphs (with frequency on X-axis and amplitude on Y-axis) illustrating the manner in which an amplified signal may occupy a different/more frequency range than the frequency range of the input signal (path 134).

FIG. 3A represents one of the multi-tone input signal 240 provided to a non linear line driver (140). FIG. 3B represents the amplified signal obtained from the line driver 140 corresponding to input signal 240. The amplified signal is shown containing bands 347-353. Each band is described below in further detail.

Band 350 represents amplified input signal 240, and both the signals have the same frequency range f4 to f5. Bands (Interference bands) 347-349 and 351-353 represent additional frequency components (interference) generated by driver 140. Bands 347-349 and 351-353 are shown respectively having frequency ranges −fc to −fb, −fb to −fa, −fa-f4, f5 to fa, fa to fb, and fb to fc. The additional frequency bands are generated due to non-linearity of line driver 140.

As further illustration, an ideal amplification operation may be represented as:
y1(t)=A*x(t) Equation (1)
wherein y(t) represents amplified output, x(t) represents an input and ‘A’ represents an amplification factor.

However, a non-linear amplification operation may be represented as (assuming only components to the third order are of interest):
y2(t)=K+A*x(t)+B*x(t)ˆˆ2 +C*x(t) ˆˆ3 Equation (2)

wherein ^represents a ‘power of’ operation, and * and +represent multiplication and addition arithmetic operations respectively. Typically square or ‘power of’ operation on signal x(t) results in signals having frequency higher and lower than the input signal x(t) as is well known in the art. Accordingly, the bands 347-349 may represent the signal generated due to such ‘power of operation’.

Frequency ranges of interference bands 347-349 and 351-353 may potentially overlap with the receive bands 210, 230 and 250 and may introduce error in recovery of the information in the received signal. Interference is often referred as in-band interference since the interference bands are over lapping with the receive bands. In one prior approach, such interference is reduced by reducing the non-linearity of the line driver thereby making the line driver expensive and bulky.

In another prior embodiment, a countering circuit is introduced after line driver 140 to attenuate the interference in the transmitter. Such an approach requires exact modeling of line driver. Further such approaches may not provide desired reduction in the interference caused due to dynamic changes in the line driver characteristics. Various aspect of present invention overcome at least some of the disadvantages described above.

5. Novel Approach to Reduce Interference

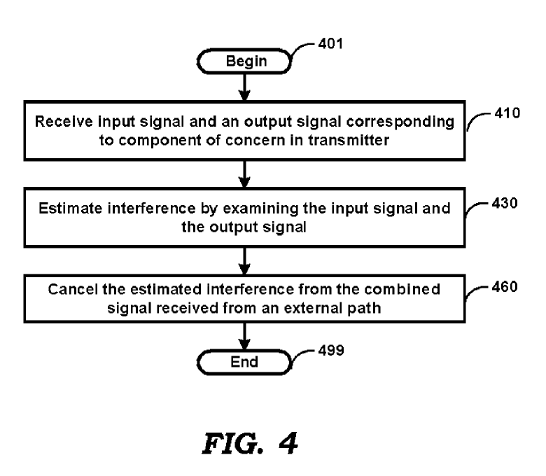

FIG. 4 is a flowchart illustrating an approach to reduce interference in a transceiver according to an aspect of the present invention. The flow chart is described with respect to transceiver 100 for illustration. However, the features can be implemented in other environments as well. The flowchart begins in step 401 and control passes to step 410.

In step 410, transceiver 100 receives an input signal and an output signal corresponding to component(s) of concern in transmitter. Assuming only the non-linearity of driver 140 is of concern, input signal and output signal can be received from paths 134 and 149 respectively.

In step 430, transceiver 100 estimates the interference by examining the input signal and the output signal. In one embodiment, estimation entails first scaling the input signal consistent with the expected linear operation, and then subtracting the resulting signal from the output signal (149). With respect to the Equations 1 and 2 noted above, the interference would equal y2(t)-(y1(t).

In step 460, transceiver cancels the estimated interference from the combined signal received from external path 169. As may be appreciated, external path 169 would receive both an external signal (containing information of interest) and interference on path 146. The resulting canceled signal can be used to recover the information of interest accurately. The flow chart ends in step 499.

Due to the above approach, modeling of the transmitter components such as line driver 140, modulator 130 etc., may be avoided. Also, the degree of reduction in the interference achieved may be independent of degree of non-linearity of the driver. As a result line drivers and other components may be implemented with lesser precision thereby reducing the cost of the transceiver. Further, filtering requirement at the receiver may be eliminated/reduced resulting in further reduction in cost, size and power consumption.

It should be appreciated that the features described above can be implemented in various embodiments. The description is continued with respect to an example architecture implementing some of the features.

6. Architecture

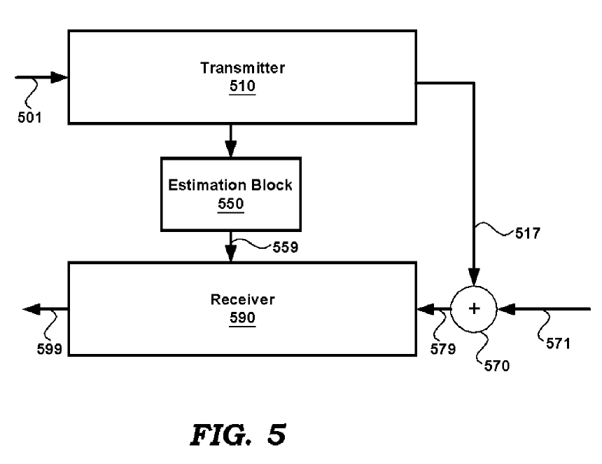

An example embodiment in which various aspects of present invention are implemented is described below with reference to FIG. 5. Shown there is block diagram containing transmitter 510, interference determination block 550, adder 570, and receiver 590. Each block is described below in further detail.

Transmitter 510 performs operations similar to transmitter 110 described in FIG. 1. Briefly, transmitter 510 receives data bits on path 501 and modulates the bits using a carrier frequency. The modulated signal is amplified using a amplifier/driver and transmitted on a desired channel.

Adder 570 receives an external signal (containing information of interest) on path 571 and interference signal on path 517, and generates a combined signal representing the sum of the external signal and the interference on path 579. It may be appreciated that adder 570 is a symbolic adder, which occurs naturally at the input of receiver 590.

Interference determination block 550 receives signals from transmitter 510, and estimates the magnitude of the interference. The estimated magnitude is provided to receiver 590.

Receiver 590 receives a combined signal on path 579 and the magnitude of interference signal on path 559. The magnitude is used to cancel the interference contained in the combined signal, while processing the combined signal. It should be appreciated that the cancellation can be performed after the digital bits are recovered from the combined signal (i.e., after path 599 in the signal path).

Receiver 590 demodulates the signal received on path 579 to generate received data bits. Received data bits are provided on path 599 for further processing. An example embodiment illustrating the manner in which estimation and corrections may be performed, is described below in further detail.

7. Implementation Details

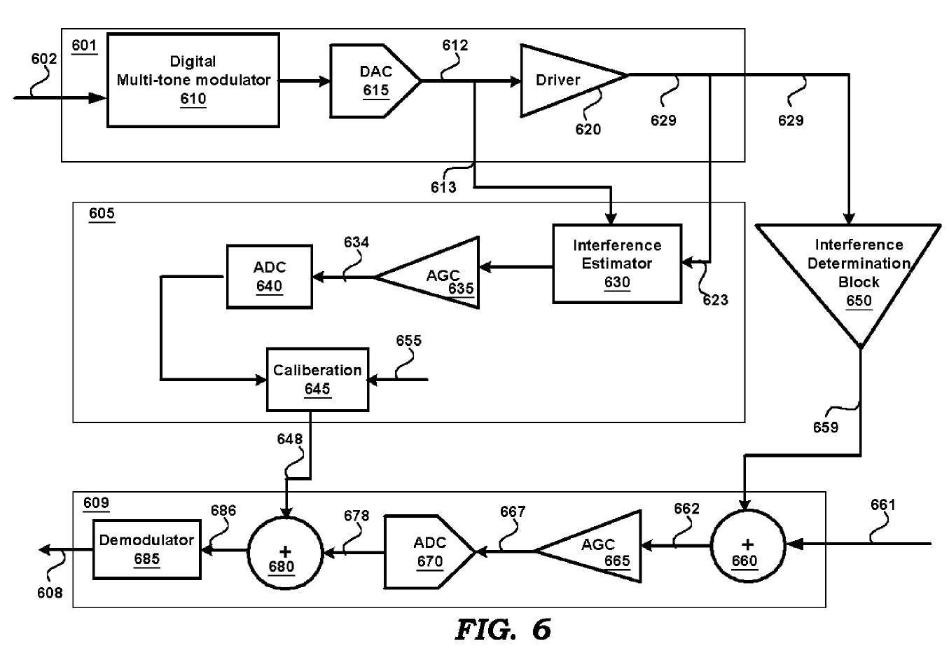

FIG. 6 is a block diagram illustrating the details of an example transceiver providing correction to interference caused due to driver non-linearity in an embodiment of the present invention. The block diagram is shown containing transmitter 601, receiver 609, interference determination block 605 and interference estimation block 650. Each block is described bellow in further detail.

Transmitter 601 is shown further comprising digital multi-tone modulator 610, digital to analog converter (DAC) 615 and line driver (driver) 620. Digital multi-tone modulator 610 receives a sequence of symbols and generates digital multi-tone signal using multiple carrier signals/frequencies. Digital to analog converter (DAC) 615 receives digital multi-tone signals and converts the signals into analog multi tone (modulated) signal x(t) on path 612.

Line driver 620 receives analog multi tone signal x(t) as input signal on path 612 and generates an amplified (transmit) signal y(t) on path 629 as output signal. The amplified signal may contain addition frequency components apart from the frequency components of the multi tone signal received on path 612. Transmit signal is transmitted on path 629.

Interference prediction block 605 predicts the magnitude of interference generated by driver 620 and provides the estimated magnitude (e.g., as a number) to receiver 609. Interference prediction block 605 is shown containing interference estimator 630, automatic gain controller (AGC) 635, ADC (analog to digital converter) 640 and calibration block 645. Operation of each block is described below in further detail.

Interference estimator receives two signals x(t) and y(t) respectively on paths 613 and 623. Signal x(t) received on path 613 represents input signal provided to driver 620 on path 612. Signal y(t) received on path 623 represents output signal obtained from driver on path 629. Interference estimator generates an estimated interference n(t) given by:
n(t)=[(y(t)/GLD)−x(t)] Equation (3)
wherein GLD represents a linear gain (A in equation (2) noted above) for which driver 620 is designed. The output signal y(t) may be represented as:
y(t)=D(x(t−Tld)) Equation (4)
wherein D( ) represents a driver transfer function and Tld represents a delay (propagation delay of the driver).

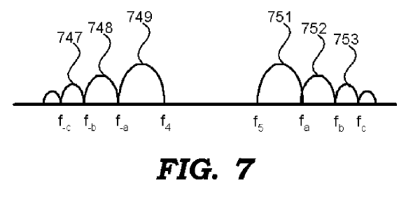

For example, assuming an input signal x(t) given by FIG. 3A and driver transfer function D( ) given in equation 2, the output signal y(t) (according to equation 4) may be represented as in FIG. 3B. The estimated interference n(t) is represented by FIG. 7. FIG. 7 is shown containing only the interference bands 747-749 and 757-753 representing interface bands 347-349 and 351-353 (of FIG. 3B), attenuated by a factor GLD.

Estimated interference n(t) is provided to automatic gain control (AGC) 635. The estimated interference n(t) is amplified to a desired level by AGC 635 and provided to ADC 640 on path 634. ADC 640 samples signal received on path 634 at desired sampling frequency (based on the frequency components of signal n(t)) and generates a digital code corresponding to each sampled value. Digital code is provided to calibration block 645.

Calibration block 645 scales each received digital code by a scaling factor SF, and provides the scaled digital codes to receiver 609 on path 648. SF represents the factor by which the interference would be scaled down in propagation from transmitter 601 (specifically, path 629) to receiver 609 (path 622), as represented by interference estimation block 650.

The scaled digital code on path 648 represents the magnitude of interference determined by interference determination block 650. The signal on path 655 controls (determines) scaling factor SF. SF can be determined based on appropriate modeling of various paths the interference passes through.

In an alternative embodiment, calibration block 645 may be implemented as filter block filtering each received signal code so as to emulate the operation of interference estimation block 650, and provides the filtered digital codes to receiver 609 on path 648. The signal path 655 controls (determines) the filter coefficients which are required for implementation of block 645. The filter coefficients can be calibrated (determined) based on appropriate modeling of various paths the interference passes through on its way from the line driver 620 to the adder 680.

Adder 660 is shown receiving a external signal (containing information of interest) on path 661 and interference signal (fraction of transmit signal on path 629) on path 659. Signal received on path 659 may represent an attenuated transmit signal (example of an interference) on path 629. Interference estimation block represents a attenuation of transmit signal reaching the receiver 690 through various (leakage) paths. Interference estimation block 650 may take

into account any other interference cancellation scheme that may be employed. For example, if a hybrid based interference cancellation is employed in a DSL system, then the interference estimation block 650 models the residual interference present in the received signal after the Hybrid based interference cancels/removes a part of the interference.

Summer 660 is symbolically shown as adding the interference signal received on path 659 and external signal to generate a combined signal on path 662. The combined signal (sum of interference signal and a external signal) is provided to receiver 690 on path 662.

Receiver 609 is shown receiving a combined signal (containing an external signal and a interference signal) on path 662 and a magnitude of estimated interference on path 648. Receiver 609 uses magnitude received on path 648 to reduce/cancel interference signal component in the combined signal received on path 662. Receiver 662 is shown containing automatic gain controller (AGC) 665, analog to digital converter (ADC) 670, subtractor 680 and multi-tone demodulator (demodulator) 685. The operation of each block is described below in further detail.

Automatic gain controller (AGC) 665 receives the combined signal on path 662 and provides the required amplification to the received combined signal to substantially maintain the power of amplified signal same at all time. The amplified combined signal is provided to ADC on path 667.

Analog to digital converter (ADC) 670 receives amplified combined signal and generates a digital signal (on path 678) representing the received combined signal. Subtractor 680 subtracts the magnitude received on path 648 from the digital signal (representing the combined signal on path 678) to cancel the undesired interference.

Demodulator 685 demodulates the result of subtraction (received on path 686) to generate the sequence of symbols (forming information of interest). The symbols may be provided to processing block 150 for further processing.

It should be appreciated that the symbols thus generated could accurately represent a sequence of symbols transmitted by a sending device (not shown, but similar to transmitter 601/110) since the error can be accurately estimated in interference determination block 605 and canceled in subtractor 680. It should be appreciated that the cancellation can be performed potentially within processing block 150 as well.

From the above, it may be appreciated that the embodiments described above perform interference cancellation in digital domain. Therefore, the interference cancellation approaches may not be limited by analog components, a problem faced by “Hybrid” based interference cancellation approaches often employed in analog domain.

Although the Hybrid based interference cancels or removes the bulk of interference, it cannot remove the interference completely. Several features of the present invention are aimed at removing the residual interference, i.e., it is not intended to be a substitute, but a supplement to the Hybrid based interference cancellation. As a result, interference cancellation performance is enhanced and line drivers type components may be implemented with lesser precision thereby reducing the cost of the transceiver. Further, filtering requirements at the receiver may also be eliminated/reduced resulting in further reduction in cost, size and power consumption.

8. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A transceiver comprising:
a transmitter transmitting a first signal to an external medium, said first signal including an interference and also information sought to be transmitted;
an estimator being coupled to said transmitter and estimating a magnitude of said interference; and
a receiver receiving a combined signal on a first path, said combined signal including an external signal and said interference, said external signal containing an information of interest sought to be received,
wherein said interference is canceled while processing said combined signal such that said information of interest can be accurately generated from said combined signal.

2. The transceiver of claim 1, wherein a frequency band of said interference overlaps with a frequency band of said external signal.

3. The transceiver of claim 2, wherein said receiver receives said magnitude on a second path, and said canceled is performed in said receiver.

4. A transceiver comprising:
a transmitter containing a set of components, said set of components receiving an input signal and generating an output signal based on said input signal, said output signal containing an interference;
a receiver receiving a combined signal containing an external signal and said interference, said external signal containing information of interest; and
an estimation block estimating a magnitude of said interference based on said input signal and said output signal,
wherein said magnitude is used to cancel said interference from said combined signal.

5. The transceiver of claim 4, wherein said set of components comprises a driver which receives an analog signal as said input signal, amplifies said analog signal to generate said output signal containing said interference along with an amplified signal of said analog signal.

6. The transceiver of claim 5, wherein a frequency band of said interference overlaps with a frequency band of said external signal.

7. The transceiver of claim 5, wherein said receiver comprises a subtractor which cancels said interference from said combined signal, said subtractor receiving said measure from said estimation block.

8. The transceiver of claim 7, wherein said estimation block provides said magnitude in the form of an analog estimate signal, said transceiver further comprising:
a first analog to digital converter to generate a first plurality of digital codes from said analog estimate signal; and
a calibration block scaling said first plurality of digital codes to generate a second plurality of digital codes.

9. The transceiver of claim 8, wherein said receiver further comprises:
an automatic gain control (AGC) receiving said combined signal and providing a gained signal of said combined signal;
a second analog to digital converter (ADC) generating a third plurality of digital codes by sampling said gained signal;
wherein said subtractor cancels said interference by processing said second plurality of digital codes and said third plurality of digital codes, and generating a fourth plurality of digital codes, and
a decoder examining said fourth plurality of digital codes to generate said information of interest.

10. The transceiver of claim 9, wherein said calibration block scales said first plurality of digital codes by a scaling factor determined by an attenuation of said interference in propagating from an output path of said driver to said subtractor.

11. A method of reducing an interference in a transceiver, said interference being caused by a set of components of a transmitter contained in said transceiver, said method comprising:
receiving an input signal provided to said set of components, wherein said set of components generates an output signal based on said input signal, said output signal containing said interference;
estimating said interference based on said input signal and said output signal;
receiving an external signal in a receiver contained in said transceiver, said external signal being received on a path, said path also receiving said interference such that said receiver receives a combined signal containing both said external signal and said interference on said path; and
providing a measure of said estimated interference such that said interference can be canceled at least partially in processing said combined signal while extracting information contained in said external signal.

12. The method of claim 11, wherein said set of components comprises a driver which receives an analog signal as said input signal, amplifies said analog signal to generate said output signal containing said interference.

13. The method of claim 2, wherein a frequency band of said interference overlaps with a frequency band of said external signal.

14. The method of claim 11, further comprising receiving said measure of said estimated interference in said receiver.

15. The method of claim 14, further comprising subtracting said measure from said external signal to cancel interference from said combined signal.

16. The method of claim 15, wherein said transceiver is comprised in a DSL modem.

17. A system reducing an interference caused by a set of components of a transmitter contained in said transceiver, said system comprising:
means for receiving an input signal provided to said set of components, wherein said set of components generates an output signal based on said input signal, said output signal containing said interference;
means for estimating said interference based on said input signal and said output signal;
means for receiving an external signal in a receiver contained in said transceiver, said external signal being received on a path, said path also receiving said interference such that said receiver receives a combined signal containing both said external signal and said interference on said path;
means for providing a measure of said estimated interference such that said interference can be canceled at least partially in processing said combined signal while extracting information contained in said external signal; and
a processing block processing said information contained in said external signal.

18. The system of claim 17, wherein said set of components comprises a driver which receives an analog signal as said input signal, amplifies said analog signal to generate said output signal containing said interference.

19. The system of claim 18, wherein a frequency band of said interference overlaps with a frequency band of said external signal.

20. The system of claim 19, where in said means for receiving an external signal receives said measure of said estimated interference in said receiver.

21. The system of claim 18, where in said means for providing a measure of said estimated interference comprising subtracting said measure from said external signal to cancel interference from said combined signal.

22. The system of claim 17, further comprising means for converting said information to a plurality of digital codes.

23. The system of claim 22, wherein said processing block operates in digital mode to process said plurality of digital codes.
